(19) United States
(12) Patent Application Publication
(10) Pub. No.: US 2020/0233454 A1
(43) Pub. Date: Jul. 23, 2020

(54) SOCIAL WEARABLE SYSTEM AND METHOD

(71) Applicant: GoGlowe, Inc., Minnetonka, MN (US)

(72) Inventor: James Clark, Minnetonka, MN (US)

(21) Appl. No.: 16/749,417

(22) Filed: Jan. 22, 2020

Related U.S. Application Data
(60) Provisional application No. 62/795,769, filed on Jan. 23, 2019.

(51) Int. Cl. G06F 1/16; G06Q 50/00; H04L 12/58

(52) U.S. Cl. CPC G06F 1/163; H04L 51/32; H04L 51/24; G06Q 50/01

(57) ABSTRACT

A social wearable including a controller, a power source, a display, a sound emitting mechanism and a vibration emitting mechanism. The controller is capable of wirelessly receiving an alert when a social media posting is detected on a social media service. The power source is operably connected to the controller. The display has an array of light sources operably connected to the controller. The sound emitting mechanism is operably connected to the controller. The vibration emitting mechanism is operably connected to the controller. A notification is defined relating to the social media posting, wherein the controller activates at least one of the display, the sound emitting mechanism and the vibration emitting mechanism that are associated with the notification to alert a person associated with the social wearable that the social media posting has been detected.

### REFERENCE TO RELATED APPLICATION

This application claims priority to U.S. Applic. No. 62/795,769, which was filed on Jan. 23, 2019. The contents of which are incorporated herein by reference.

### FIELD OF THE INVENTION

The invention relates generally to a system and method that is used in conjunction with communicating via social media. More particularly, the invention relates to a social wearable system and method of use.

### BACKGROUND OF THE INVENTION

Social media is defined as websites and applications that enable users to create and share content or to participate in social networking. There are many ways by which a person can receive notifications about receipt of social networking content. Examples of which include displaying a textual message, emitting a sound, emitting a vibration and illuminating a light.

When the person has a large number of social media connections, there may be challenges reviewing the notifications to determine which notifications should be acted on and which notifications should be ignored. Additionally, receiving a large number of notifications may negatively impact the ability of the person to perform other tasks.

### SUMMARY OF THE INVENTION

An embodiment of the invention is directed to a social wearable that includes a controller, a power source, a display, a sound emitting mechanism and a vibration emitting mechanism. The controller is capable of wirelessly receiving an alert when a social media posting is detected on a social media service. The power source is operably connected to the controller. The display has an array of light sources operably connected to the controller. The sound emitting mechanism is operably connected to the controller. The vibration emitting mechanism is operably connected to the controller. A notification is defined relating to the social media posting. The controller activates at least one of the display, the sound emitting mechanism and the vibration emitting mechanism that are associated with the notification to alert a person associated with the social wearable that the social media posting has been detected.

Another embodiment of the invention is directed to a social interaction system that include a social wearable and a portable communication device. The social wearable includes a controller, a power source, a display, a sound emitting mechanism and a vibration emitting mechanism. The controller is capable of wirelessly receiving an alert when a social media posting is detected on a social media service. The power source is operably connected to the controller. The display has an array of light sources operably connected to the controller. The sound emitting mechanism is operably connected to the controller. The vibration emitting mechanism is operably connected to the controller. The notification is defined relating to the social media posting, wherein the controller activates at least one of the display, the sound emitting mechanism and the vibration emitting mechanism that are associated with the notification to alert a person associated with the social wearable that the social media posting has been detected. The portable communication device for defining the notification and then transmitting the notification to the social wearable.

Another embodiment of the invention is directed to a social interaction method. A social wearable is provided that includes a controller, a power source, a display, a sound emitting mechanism and a vibration emitting mechanism. The power source is operably connected to the controller. The display has an array of light sources that are operably connected to the controller. The sound emitting mechanism is operably connected to the controller. The vibration emitting mechanism is operably connected to the controller. A first notification is defined that includes at least one of an illumination, a sound and a vibration. The first notification is associated with a first social media posting. A social media service is monitored for the first social media posting. The first notification is activated on the social wearable in response to detecting the first social media posting. The first notification is emitted using the social wearable.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a social wearable for use in conjunction with the mobile application where the social wearable is in a non-illuminated configuration.

FIG. 2 is a perspective view of the social wearable in a first illuminated configuration.

FIG. 3 is a perspective view of the social wearable in a second illuminated configuration.

FIG. 4 is a perspective view of the social wearable in a third illuminated configuration.

FIG. 5 is a dashboard in a mobile application for use in conjunction with an embodiment of the invention.

FIG. 6 is a saved code screen in the mobile application for use in conjunction with an embodiment of the invention.

FIG. 7 is a new code creation screen in the mobile application for use in conjunction with an embodiment of the invention.

FIG. 8 is a notification list in the mobile application for use in conjunction with an embodiment of the invention.

FIG. 9 is a social connect screen in the mobile application.

### DETAILED DESCRIPTION OF THE INVENTION

An embodiment of the invention is directed to a social wearable system and method of use. The system and method may have to primary functions as a beacon of important stuff and as a messaging system that can be accessed without the user viewing his/her smartphone.

With respect to the first function, the system and method connects to social platforms and allows the user to filter and receive notifications through customized sense-based signals (light, pattern, sound and/or vibration) and control which incoming notifications are received.

With respect to the second function, the system and method connects users on the network associated with the system and method and allows the users to send and receive customized sense-based signals (light, pattern, sound and/or vibration) to each other as messages that take on meaning.

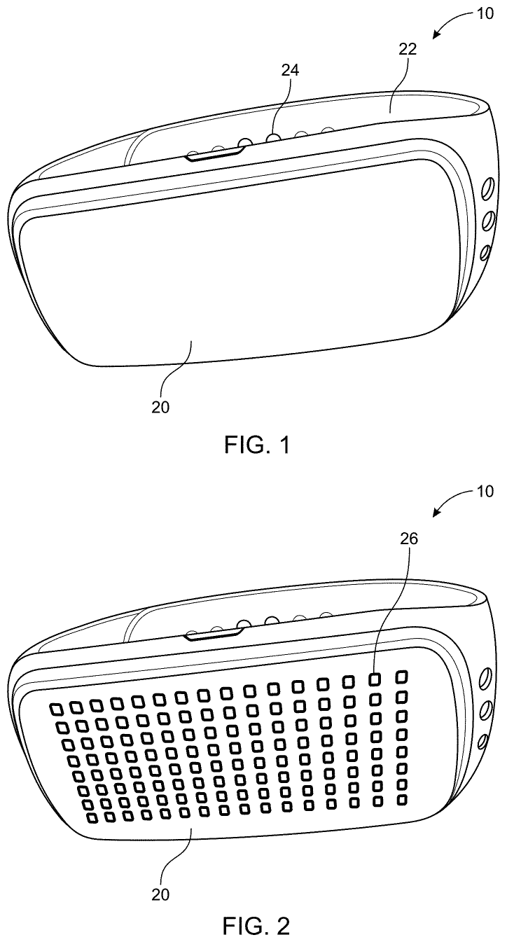

The social wearable may assume a variety of forms using the concepts of the invention. In one such embodiment, the social wearable is configured to be worn on a person's wrist similar to a watch such as illustrated at 10 in FIG. 1.

In another embodiment, the social wearable may also be configured to be worn on a person's finger similar to a ring. In yet another embodiment, the social wearable may be associated with a necklace or bracelet similar to a pendant.

An important aspect of the manner in which the social wearable 10 is configured is that the person wearing the social wearable 10 is able to receive social media notifications and/or social media content. The social media notifications and/or social media content may be received in at least one way of displaying text, emitting sound, emitting vibration and illuminating light.

The social wearable 10 thereby enables the person to engage in sense-based messaging, whereby the person receives at least one of a notification and its content without the person viewing a mobile communication device such as a mobile phone.

In addition to enabling the person to engage in sense-based messaging, the social wearable 10 also conveys to others who see the person wearing the social wearable 10 that the person desires social interaction. In such situations, the social wearable may be worn on a portion of the person's body that enables others to readily identify the presence of the social wearable 10.

The social wearable 10 includes a display 20. The configuration of the display 20 may have a variety of forms. In its most basic form, the display 20 is capable of illuminating in at least one color. It is also possible for the display 20 to be able to display text and/or images.

Another configuration of the display 20 includes an array of light sources 26 that are arranged in a series of rows and a series of columns such as illustrated in FIGS. 2-4. The number of light sources 26 may be selected based upon a variety of factors such as the nature of text and/or images that are intended to be displayed on the display 20.

In one such embodiment, there are between about 5 rows and about 10 rows of light sources 26 and there are between about 10 columns and about 20 columns of light sources. In another embodiment, there are 8 rows of light sources and 16 columns of light sources 26.

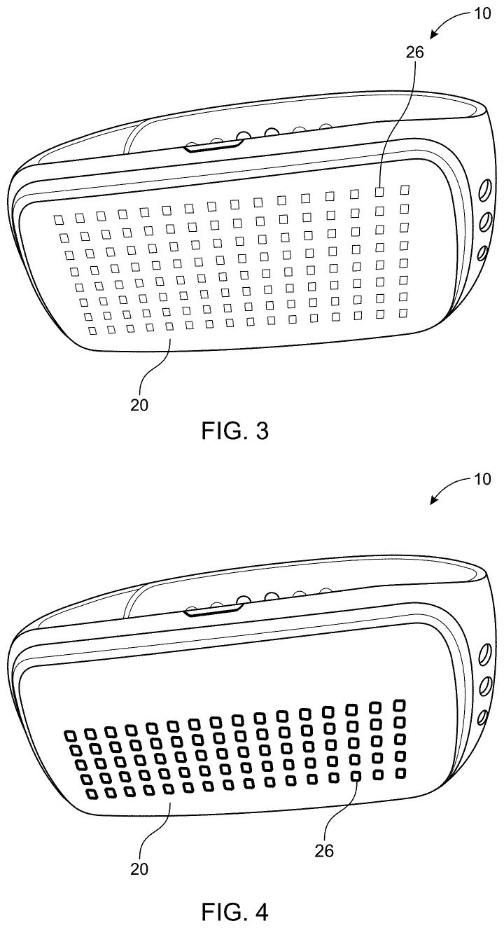

In addition to the light sources 26 being on or off, the light sources 26 may be illuminated at different intensities. For example, FIG. 2 illustrates the light sources 26 at a greater intensity as compared to the light sources 26 in FIG. 3.

Less than all of the light sources 26 may also be illuminated such as illustrated in FIG. 4. The light sources 26 may also be illuminated in a pattern that identifies an aspect of the message and/or the sender of the message.

For example, the light sources 26 may be illuminated in a shape such as an emoji. The light sources 26 may be illuminated in a geometric shape. While it is also possible for the light sources to illuminate in the form of letters and/or numbers. However, illumination of the light sources 26 in other than letters and/or numbers enables the message conveyed by the illuminated light sources 26 to be communicated in secret such that the content of the message such may not be readily understood by persons other than the person sending and receiving the message.

The social wearable 10 also includes a band 22 that is capable of at least partially extending around the wrist of the person who is using the social wearable 10. The band 22 may be configured to be readily attached to and detached from the person's wrist. In one such embodiment, the band 22 includes two sections that are capable of engaging each other with a clasp 24. A person of skill in the art will appreciate that the clasp 24 may assume a variety of configurations using the concepts of the invention.

The social wearable 10 includes a sound emitting mechanism (not shown) operably attached thereto. In certain embodiments, the sound emitting mechanism is a speaker. The sound emitting mechanism may be on the surface of the social wearable 10. In other embodiments, the sound emitting mechanism may be recessed inside of the social wearable 10.

The social wearable 10 includes a vibration emitting mechanism (not shown) operably attached thereto. The vibration emitting mechanism may be recessed inside of the social wearable 10.

The social wearable 10 also includes a power source (not shown) such as a battery that is operably attached thereto. In certain embodiments, the power source is mounted substantially inside of the social wearable 10. The power source may be rechargeable when depleted or the power source may be replaceable when depleted. In embodiments where the power source is rechargeable, a port may be provided on the social wearable 10 for recharging the power source.

The social wearable 10 also includes a communication mechanism (not shown) operably mounted therein. The communication mechanism may assume a variety of configurations such as Bluetooth and Wi-Fi. It is also possible for the communication mechanism to communicate directly with a communication network similar to a mobile phone.

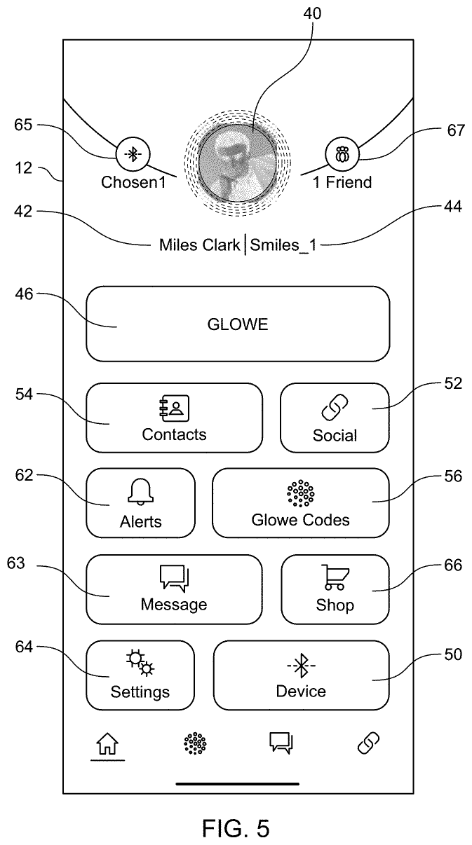

In one configuration of using the social wearable 10, an application is provided on a portable communication device such as a mobile phone 12 for utilizing the features of the social wearable 10. An example of one such application is illustrated in FIG. 5. The application may include an initial screen, which is illustrated in FIG. 5, which includes the ability to access a variety of functions. A person of skill in the art will appreciate that other techniques may be used in conjunction with the method of using the social wearable 10, an example of one such alternative technique is a web browser.

The initial screen may also include an image 40 of the user or an alternative image selected by the user, the user's name 42, the user's user name 44 for the social interaction system, and the number of connections 67 (or friends) of the user and an identifier 65 of the nature of the connection such as Bluetooth or Wi-Fi. The initial screen may also include a trademark 46 associated with the entity that operates the software.

One function is to connect the application to the social wearable 10 using a connection button 50, which is identified as Glowe Device. The connection between the application and the social wearable 10 may be accomplished using a variety of mechanisms, examples of which include Bluetooth, Wi-Fi and cellular networks. Each person will connect the social wearable 10 to the mobile phone on which the person is using the application unless the social wearable 10 includes the ability to communicate using cellular networks.

The application includes a social media connection button 52 to access a social connection screen that is used by the user to associate the social wearable system with social media systems, examples of which include Facebook, Snapchat and Instagram.

The application includes a contacts button 54 to access a contacts screen that includes a list of the contacts of the user. The contacts screen may also include the ability to add, delete and modify contacts.

The application includes a codes button 56 to access a codes screen that is used to define codes that the user uses to communicate with his/her contacts. The codes screen may also include a list of the codes that have been previously defined by the user.

The application also includes an alerts button 62 that is used to control the alerts that are provided by the social wearable application on the mobile device 12. Non-limiting examples of the alerts include emitting a sound, illuminating a light and vibration of the mobile device 12. The system may also enable certain alerts to be toggled on and off.

The application may also include a messages button 63 that enables the user to review and/or compose messages to other users. The application may also include a settings button 64 that is used to access a setting screen where aspects of the application can be configured. The application may also include a shopping button 66 that is used to access a shopping screen where a user can make purchases relating to the social wearable system.

The application may include a button (not shown) to access a tutorials screen where a user can obtain instructions on the use of aspects of the social wearable system. A person of skill in the art will appreciate that the tutorials may have a variety of formats, examples of which include videos and text.

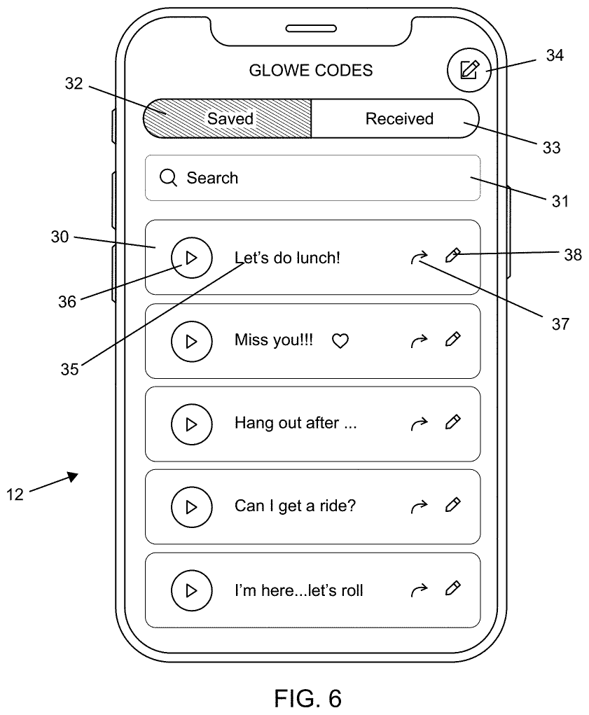

The code screen may include the ability to define aspects of the code such as illustrated in FIG. 6. The code screen may include a search box 31 that enables a user to search previously defined codes. The code screen may include the ability to toggle between saved codes 32 that were created by the user and received codes 33 that the user received from others.

The code screen include several code buttons 30. Each code button 30 may include a name 35 for the code and a play button 36 that causes the code to be played. The code button 30 may also include an edit button 38 that enables the display, sound and/or vibration associated with the code to be modified. The code button 30 may also include a send code button 37 that the user uses to send the code to another user.

A first aspect of defining the code is to enter a message 70 that will be associated with the code. The message may include items such as text and/or emojis. A variety of techniques may be used to enter the message, examples of which include typing on a keyboard and speaking.

Each of the codes may have a unique vibration associated therewith that is selected by pressing a vibration button 72. A menu may be associated with the vibration button 72 from which one of a list of previously defined vibrations may be selected. The user may also be able to define a new vibration.

Each of the codes may have a unique sound associated therewith that is selected by pressing a sound button 74. A menu may be associated with the sound button 74 from which one of a list of previously defined sounds may be selected. The user may also be able to define a new sound.

Each of the codes may have at least one unique illumination color associated therewith that is selected by pressing a color button 76. A menu may be associated with the color button 76 from which one of a list of previously defined colors may be selected. The user may also be able to define a new color.

Each of the codes may have at least one unique illumination pattern associated therewith that is selected by pressing a pattern button 78. A menu may be associated with the pattern button 78 from which one of a list of previously defined illumination patterns may be selected. The user may also be able to define a new illumination pattern.

Once the aspects of the code have been selected, the user may select a preview button 80 to evaluate the various aspects of the code. The code may be sent to another person such as one of the user's contacts by pressing a send button 82. The code may be saved by pressing a save button 84.

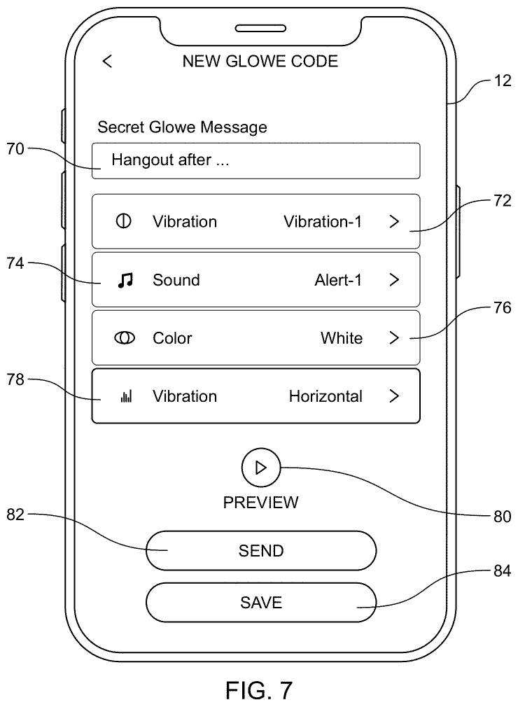

An example of a list of previously defined codes is set forth in FIG. 6. The code list screen may include the ability to search for codes as well as to filter the codes by codes the user has created and saved versus codes the user has received from other users. The code list screen may also have an icon to access a code definition screen, which is set forth in FIG. 7.

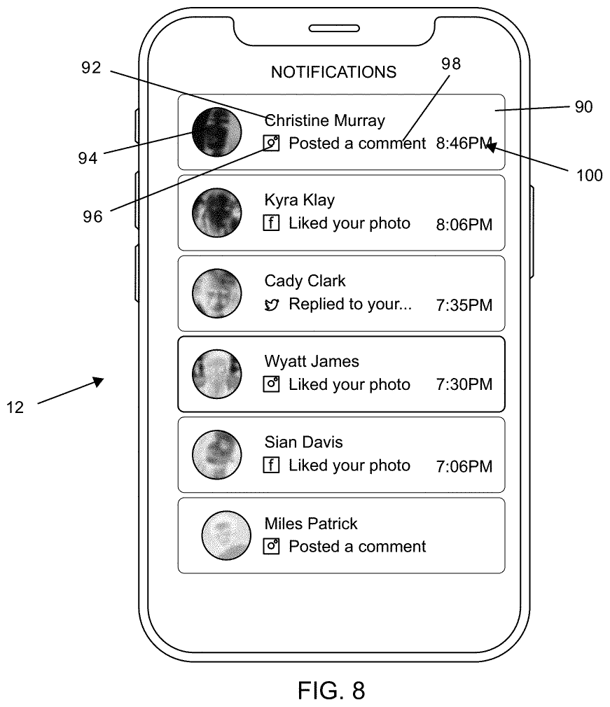

Selecting the center button on the initial screen may cause a list of notifications that have been received to be displayed, an example of which is set forth in FIG. 8. The notification list may include an image of the person associated with the notification, a name of the person associated with the notification, a time and/or date on which the notification was received, an identification of the social media platform associated with the notification and a short description of the nature of the notification, examples of which include “Posted a comment” and “Liked your photo”.

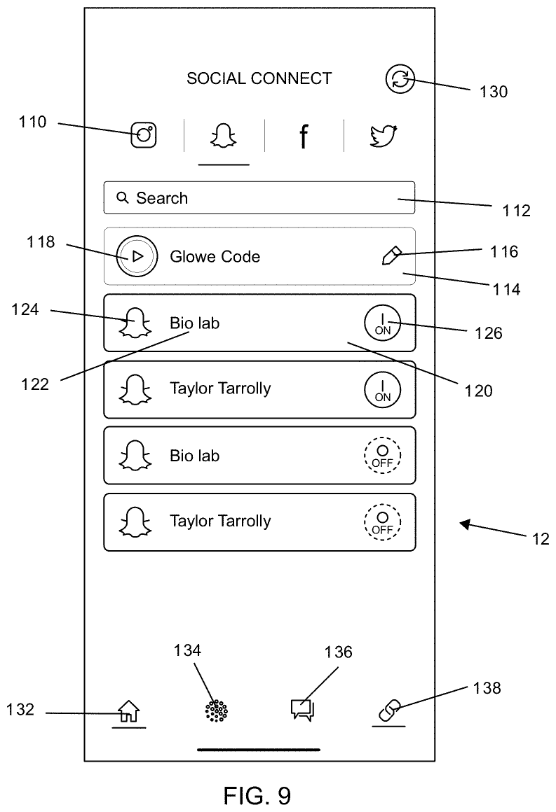

FIG. 9 illustrates a social connect screen in the mobile application. This screen enables the user to not only connect with others through social media but also enables the user to review the social media connections. Proximate the top of the social connect screen is a list of the social media services to which a connection can be made. While the social media services are identified with an icon, a person of skill in the art will appreciate that alternative techniques may be used to identify the social media services. When one of the social media services is selected, it is identified to the user such as with a line below the icon.

The social connect screen may include a search box 112 that enables a user to conduct a text search for previous connections. The social connect screen includes a define button 114 that enables a user to define new connections 116 as well as to play prior connections 118. The social connect screen may also include a refresh button 130 that causes the listing of social connections to be updated.

The social connect screen also includes several boxes 120 of the prior social connections. Each of the boxes 120 includes a name 122 that identifies the connection. The box 114 may also include an identifier 124 of the social media service associated with the connection. The box 120 may also include a button 126 that is used to toggle on and off the connection. When toggled on, notifications will be received. When toggled off, notifications will not be received.

The social connect screen may also include a button 132 to return to the home page of the social interaction application, a settings button 134 that enables the user to change settings of the social interaction application, a messages button 136 that is used to send messages using the social interaction application, and a link button 138 that enables the user to change the social media services that are linked.

In use, the user connects the social wearable 10 to the application that is installed on the mobile device 12. The user connects the application to at least one social media platform. The user connects to at least one contact with whom the person desires to communicate. The user defines at least one code by selecting a vibration, a sound, a color and/or an illumination pattern.

The user lets the intended recipient know not only the code but the significance of the code such that when the code is sent from the user to the recipient's social wearable 10 the recipient knows not only which person sent the code but also the content of the code.

When the code is sent to the recipient's social wearable 10, the only person who will know the nature of the coded message and the sender of the code is the recipient. The method of using the social wearable also enables the recipient to know that a coded message has been received without the recipient needing to view the message on the recipient's mobile device, which may enhance the productivity of the recipient.

The social wearable 10 may further include the ability for the recipient to acknowledge receipt of the coded message and/or to send a reply to the sender. An example of one such technique that may be used for the recipient to reply to the sender is at least one button on the social wearable 10 or a touch screen on the display.

In addition to receiving the code on the social wearable 10, the recipient may receive a notification on the application of the recipient's mobile device.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A social wearable comprising:
a controller that is capable of wirelessly receiving an alert when a social media posting is detected on a social media service;
a power source operably connected to the controller;
a display having an array of light sources operably connected to the controller;
a sound emitting mechanism operably connected to the controller; and
a vibration emitting mechanism operably connected to the controller, wherein a notification is defined relating to the social media posting, wherein the controller activates at least one of the display, the sound emitting mechanism and the vibration emitting mechanism that are associated with the notification to alert a person associated with the social wearable that the social media posting has been detected.

2. The social wearable of claim 1, wherein the array of lights is capable of being selectively illuminated in a variety of colors and wherein the array of lights comprises a plurality of columns and a plurality of rows.

3. The social wearable of claim 1, and further comprising an attachment device that comprises a band that is capable of extending around a portion of the wearer's body and a clasp for securing the band.

4. A social interaction system comprising:
a social wearable comprising:
a controller that is capable of wirelessly receiving an alert when a social media posting is detected on a social media service;
a power source operably connected to the controller;
a display having an array of light sources operably connected to the controller;
a sound emitting mechanism operably connected to the controller; and
a vibration emitting mechanism operably connected to the controller, wherein a notification is defined relating to the social media posting, wherein the controller activates at least one of the display, the sound emitting mechanism and the vibration emitting mechanism that are associated with the notification to alert a person associated with the social wearable that the social media posting has been detected; and
a portable communication device for defining the notification and then transmitting the notification to the social wearable.

5. The social interaction system of claim 4, wherein portable communication device is capable of defining the notification that includes at least one of an illumination, a sound and a vibration.

6. The social interaction system of claim 4, wherein the portable communication device is capable of creating a contact for a person or a group and then associating the notification with the contact.

7. The social interaction system of claim 4, wherein the notification is capable of conveying to a person wearing the social wearable at least one of an identification of the social media platform, an identity of an originator of the social media posting and a nature of the social media posting.

8. The social interaction system of claim 4, wherein the portable communication device is capable of defining a first code that is associated with a first message, wherein the first code comprises at least one of an illumination, a sound and a vibration and wherein the portable communication device is capable of transmitting the first code to the social wearable.

9. A social interaction method comprising:
providing a social wearable comprising a controller, a power source, a display, a sound emitting mechanism and a vibration emitting mechanism, wherein the power source is operably connected to the controller, wherein the display has an array of light sources that are operably connected to the controller, wherein the sound emitting mechanism is operably connected to the controller and wherein the vibration emitting mechanism is operably connected to the controller;
defining a first notification comprising at least one of an illumination, a sound and a vibration;
associating the first notification with a first social media posting;
monitoring a social media service for the first social media posting;
activating the first notification on the social wearable in response to detecting the first social media posting; and
emitting the first notification using the social wearable.

10. The method of claim 9, wherein the defining and the associating are done on a portable communication device that is in communication with the social wearable.

11. The method of claim 9, and further comprising:
creating a contact for a person or group; and
associating the first notification with the contact.

12. The method of claim 9, and further comprising:
defining a second notification comprising at least one of an illumination, a sound and a vibration, wherein the second notification is different than the first notification;
associating the second notification with a second social media posting;
monitoring the social media service for the second social media posting;
activating the first notification on the social wearable in response to detecting the second social media posting; and
emitting the second notification using the social wearable.

13. The method of claim 9, wherein the illumination comprises an illumination color and an illumination pattern.

14. The method of claim 9, wherein the social wearable is proximate a recipient and wherein the method further comprises conveying to the recipient through the first notification at least one of an identification of the social media platform, an identity of an originator of the social media posting and a nature of the social media posting.

15. The method of claim 9, wherein the first notification is a component of a plurality of notifications and wherein the method further comprises:
emitting the first notification using the social wearable not in response to detecting the social media posting to preview the notification; and
displaying the plurality of notifications to review the plurality of notifications.

16. The method of claim 9, wherein the social wearable is proximate a recipient and wherein the first notification is a component of a plurality of notifications and wherein the method further comprises:
selecting a period of time; and
displaying a portion of the plurality of notifications that are in the period of time on a second portable communication device that is associated with the recipient.

17. The method of claim 9, and further comprising:
defining a first code that is associated with a first message, wherein the first code comprises at least one of an illumination, a sound and a vibration;
transmitting the first code to the social wearable that is proximate the recipient; and
emitting the first code using the social wearable.

18. The method of claim 17, and further comprising:
defining a second code that is associated with a second message, wherein the second code comprises at least one of an illumination, a sound and a vibration;
transmitting the second code to a source of the first message.

19. The method of claim 18, wherein the second code is different than the first code.
